(19) United States
(12) Patent Application Publication
(10) Pub. No.: US 2026/0069383 A1
(43) Pub. Date: Mar. 12, 2026

(54) READILY FINDABLE ORTHODONTIC ALIGNMENT DEVICES

(71) Applicant: Barry E. Negrin, New York, NY (US)

(72) Inventor: Barry E. Negrin, New York, NY (US)

(21) Appl. No.: 19/319,308

(22) Filed: Sep. 4, 2025

Related U.S. Application Data
(60) Provisional application No. 63/691,865, filed on Sep. 6, 2024.

(51) Int. Cl. A61C 7/08

(52) U.S. Cl. CPC A61C 7/08; A61C 2201/002

(57) ABSTRACT

A readily findable dental appliance is provided having a shell with a plurality of tooth-receiving cavities shaped to receive and resiliently reposition teeth in a patient's mouth from a first arrangement toward a second arrangement. At least one thermally-sensitive indicator is incorporated with at least a portion of the shell. The thermally-sensitive indicator includes a first temperature-activated thermochromic pigment, which preferably changes from a first visible color when below a first temperature to a second substantially clear color when above the first temperature. The pigment preferably includes a leuco dye microencapsulated in a polymer such as melamine formaldehyde polymer. A second temperature-activated thermochromic pigment may be provided that changes from a third substantially clear color when above a second temperature to a fourth visible color when below the second temperature, which is, e.g., approximately beverage-drinking temperature.

### RELATED APPLICATIONS

Priority is claimed from U.S. Provisional Ser. No. 63/691,865 filed Sep. 6, 2024 entitled READILY FINDABLE ORTHODONTIC ALIGNMENT DEVICES, the entirety of which is incorporated by reference herein.

### BACKGROUND OF THE INVENTION

### Field of the Invention

The invention relates to orthodontic tooth alignment devices, and more specifically to orthodontic tooth alignment and bite correction devices that can be easily found when not in the user's mouth.

### Description of the Related Art

Clear aligners areorthodontic devices that are a transparent, plastic form of dental braces used to adjust teeth. Experience suggests they are effective for moderate crowding of the front teeth, In particular they are indicated for mild to moderate crowding (1-6 mm) and mild to moderate spacing (1-6 mm), in cases where there are no discrepancies of the jaw bone. They are also indicated for patients who have experienced a relapse after fixed orthodontic treatment.

Clear-aligner treatment involves an orthodontist or dentist or, with home-based systems, the person themselves, taking a mold of the patient's teeth, which is used to create a digital tooth scan. The computerized model suggests stages between the current and desired teeth positions, and aligners are created for each stage. Each aligner is worn for 22 hours a day for one or two weeks. These slowly move the teeth into the position agreed between the orthodontist or dentist and the patient. The average treatment time is 13.5 months. Typical conventional aligners are sold by Align Technology of Tempe, AZ under the brand INVISALIGN, as well as ClearCorrect LLC of Round Rock, TX and SmileDirect Club of Nashville, TN.

Clear aligners are often preferred to conventional metal braces because they are nearly invisible to the ordinary observer when used. People, especially children, can be very self-conscious about wearing braces, especially when other people (again, especially children) can make rude comments about same.

However, the near invisibility of clear aligners can be a huge drawback when they are removed from the mouth, e.g., during eating or brushing teeth. Because they are nearly invisible and quite small, it is incredibly easy to lose them, either by putting them down and then not seeing them afterwards, or having them fall on the floor and not noticing that they are gone or where they went. The typical user is supposed to wear the same set of aligners for one to two weeks; this process gets disrupted when one or both aligners are misplaced or lost.

Accordingly, there is a long-felt need to provide orthodontic aligners that are both invisible or nearly invisible when worn but readily and easily findable when taken out of the mouth.

### SUMMARY OF THE INVENTION

The above and other objects are achieved by the invention, which is an orthodontic aligner provided with a temperature-activated thermochromic pigment or dye impregnated therein.

In one embodiment, the invention includes a dental appliance, having a shell having a plurality of tooth-receiving cavities shaped to receive and resiliently reposition teeth in a patient's mouth from a first arrangement toward a second arrangement; and at least one thermally-sensitive indicator incorporated with at least a portion of said shell. Preferably, the at least one thermally-sensitive indicator includes a first temperature-activated thermochromic pigment. Preferably, the first temperature-activated thermochromic pigment changes from a first color when below a first temperature to a second color when above the first temperature. Preferably, the first color is visible and the second color is colorless and substantially clear, and the first temperature is approximately human body temperature.

Preferably, the first temperature-activated thermochromic pigment includes a leuco dye. Optionally, the leuco dye is microencapsulated in a polymer. Optionally, the polymer includes melamine formaldehyde polymer.

Optionally, the at least one thermally-sensitive indicator includes a second temperature-activated thermochromic pigment that changes from a third color when above a second temperature to a fourth color when below the second temperature. Optionally, the fourth color is visible and the third color is colorless and substantially clear. Optionally, the second temperature is approximately beverage-drinking temperature.

In another embodiment, the invention includes a dental appliance, having a shell having a plurality of tooth-receiving cavities; and at least one thermally-sensitive indicator incorporated with at least a portion of the shell. Preferably, the at least one thermally-sensitive indicator comprises a first temperature-activated thermochromic pigment. Optionally, the first temperature-activated thermochromic pigment changes from a first color when below a first temperature to a second color when above the first temperature. The first color is preferably visible and the second color is colorless and substantially clear, and wherein the first temperature is approximately human body temperature.

The first temperature-activated thermochromic pigment is preferably a first leuco dye, and it is preferably microencapsulated in a polymer such as, e.g., melamine formaldehyde polymer.

The at least one thermally-sensitive indicator may include in addition or the alternative a temperature-activated thermochromic pigment that changes from a first color when above a second temperature to a second color when below the second temperature. In this case, the second color may optionally be visible, and the first color may optionally be colorless and substantially clear; the second temperature may be approximately beverage-drinking temperature.

### BRIEF DESCRIPTION OF THE DRAWINGS

FIG. 1 is a schematic of a conventional orthodontic clear aligner.

FIG. 2A is an image of a conventional orthodontic clear aligner resting atop a piece of paper.

FIG. 2B is an image of a conventional orthodontic clear aligner resting atop a multicolored surface.

FIG. 3 is a schematic of an orthodontic aligner in accordance with an embodiment of the invention at body temperature.

FIG. 4 is a schematic of an orthodontic aligner in accordance with an embodiment of the invention at room temperature.

FIG. 5A is a sectional view of an orthodontic aligner in accordance with an embodiment of the invention.

FIG. 5B is a sectional view of an orthodontic aligner in accordance with another embodiment of the invention.

### DETAILED DESCRIPTION OF THE DRAWINGS AND THE INVENTION

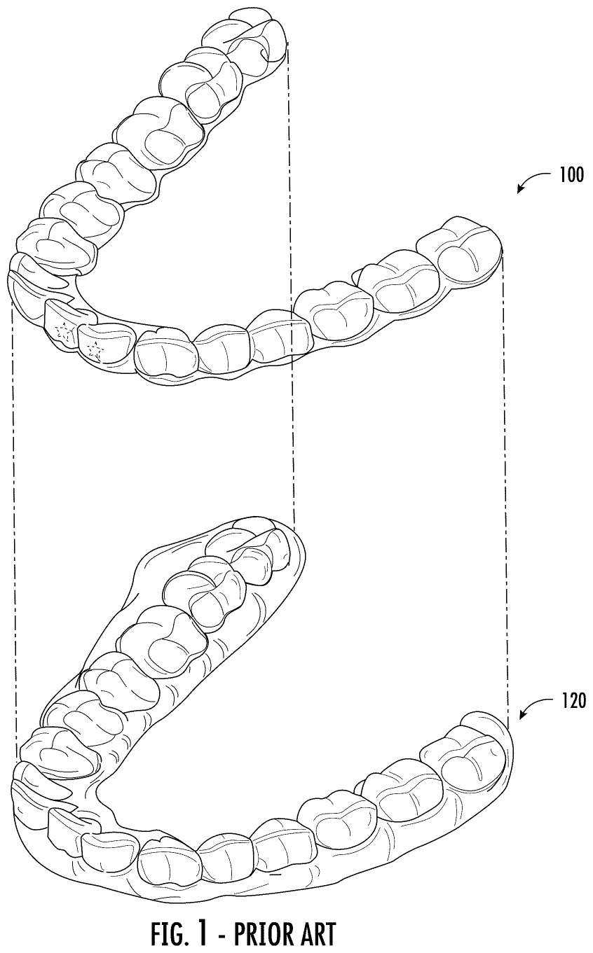

Description will now be given with reference to the attached FIGS. 1-5. It should be understood that these figures are exemplary in nature and in no way serve to limit the scope of the invention, which is defined by the claims appearing hereinbelow.

Embodiments of a dental appliance will be described herein. In an illustrated embodiment, the dental appliance 100 has a geometry for receiving teeth. As shown in FIG. 1, the dental appliance 100 can be configured to fit over an entire dental arch 120. In other embodiments, the dental appliance may be designed to fit over some or all of the teeth in the upper or lower jaw. The dental appliance 100 can be fabricated from a polymeric shell, or formed from another material, and include a number of cavities shaped to receive corresponding teeth.

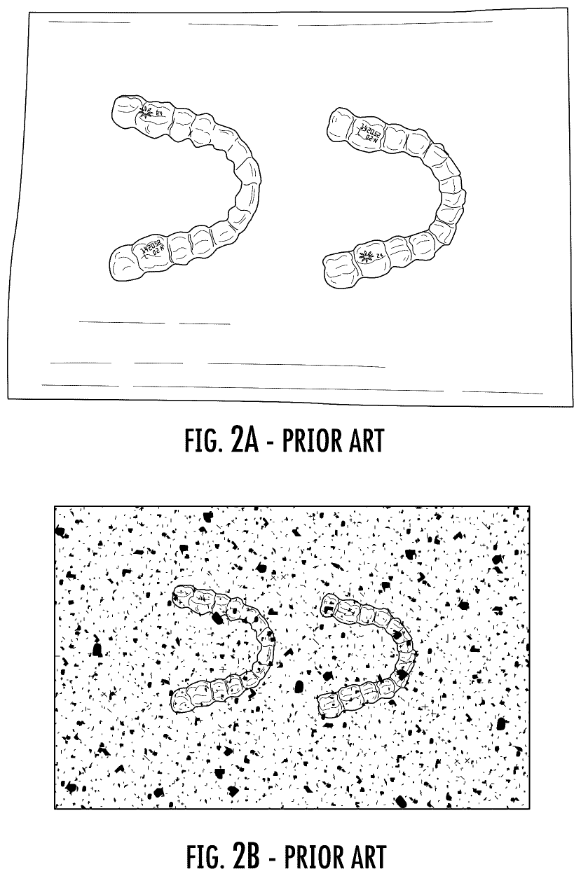

Appliance 100 is an excellent device for aligning crooked teeth, however it only works if it in the user's mouth, and it can only get into the user's mouth if the user can find it. FIG. 2A is an image of a conventional orthodontic clear aligner appliance 100 resting atop a piece of paper. It is fairly visible. By contrast, FIG. 2B is an image of appliance 100 resting atop a multicolored surface such as a granite kitchen counter. It is much harder to see, especially from a distance or at an angle. Under different or lower lighting conditions, appliance 100 can be basically invisible. Aligners are meant to be nearly invisible when worn, but that quality makes them difficult to find when the user puts them down e.g., when eating.

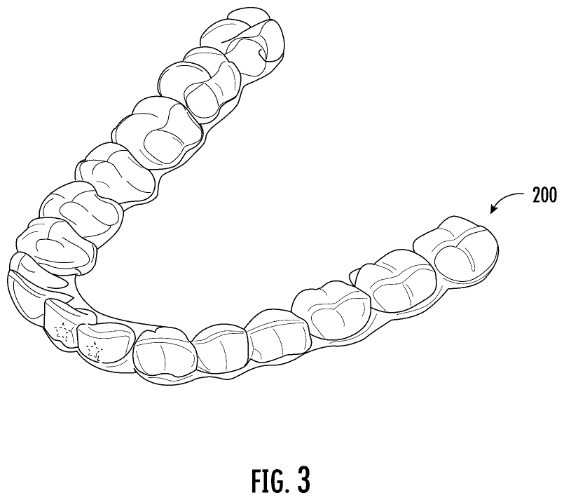

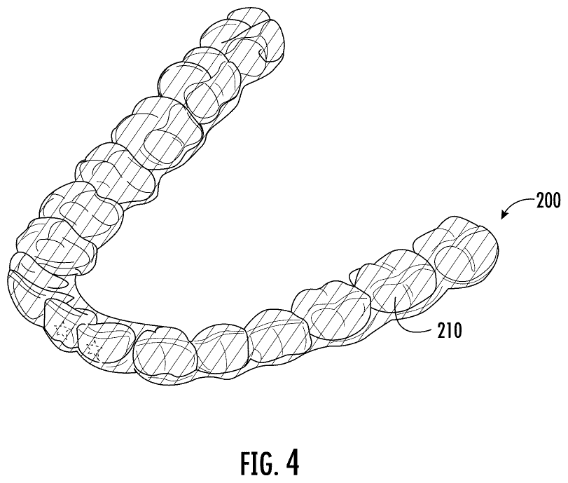

FIG. 3 is a schematic of an orthodontic aligner 200 in accordance with an embodiment of the invention at body temperature. It is substantially clear and colorless as conventional aligners are. However, FIG. 4 is a schematic of aligner 200 at room temperature. It is colored (transparent, translucent, opaque, or combinations thereof), because of the incorporation of a thermally-sensitive indicator 210 within at least a portion of aligner 200. As an example, thermally-sensitive indicator 210 includes a temperature-activated thermochromic pigment that changes from a first color when below a first temperature to a second color when above that first temperature. As shown in FIG. 4, the aligner has a visible color to make it easier to find when it is out of the user's mouth. As shown in FIG. 3, the aligner is colorless and substantially clear. The temperature-activated thermochromic pigment changes from colored to clear when it is exposed to temperatures at or above typical human body/mouth temperature, e.g., approximately 90-100° F. The temperature-activated thermochromic pigment may include a leuco dye that changes color at that temperature. Exemplary leuco dyes are black/colorless 82F pigment and black/colorless 100F sold by Atlanta Chemical Engineering LLC of Riverview, FL.

Although there are relatively safe leuco dyes, it is probably advantageous to prevent it from leaching out of appliance 200 and into the user's mouth. As such, in one embodiment, the leuco dye may be microencapsulated in a polymer such as, e.g., melamine formaldehyde polymer. (The 82F and 100F pigments of Atlanta Chemical Engineering are so microencapsulated.) Other polymers may be employed in addition or in the alternative.

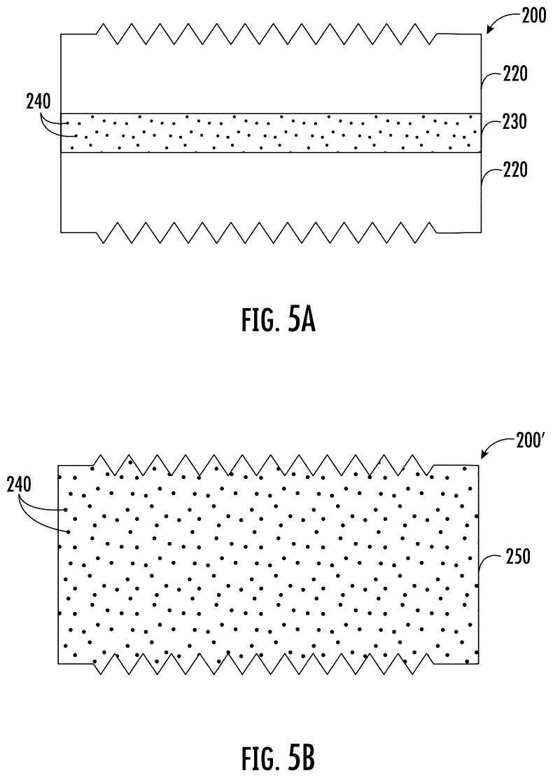

FIGS. 5A and 5B are sectional views of an orthodontic aligner in accordance with embodiments of the invention. In FIG. 5A, a layer 230 of encapsulated leuco dye 240 is sandwiched between two layers 220 of aligner polymer in aligner 200. Although three layers are shown in FIG. 5A, any number of layers can be used as long as the external layers of aligner 200 are made from aligner polymer. Alternatively, in FIG. 5B, microdots of encapsulated leuco dye 240 are provided scattered throughout aligner polymer 250 of aligner 200′. Other configurations are contemplated, e.g., only portions/sections of the aligner may be provided with temperature-activated thermochromic pigment, optionally, e.g., in a pattern (the user's name, the trademark of the aligner brand, shapes, designs, etc.).

In addition or in the alternative to the above, a second temperature-activated thermochromic pigment may be included that changes from a third color when above a second temperature to a fourth color when below that second temperature. The fourth color is optionally visible and the third color is colorless and substantially clear, with the second temperature being approximately beverage-drinking temperature, e.g., approximately 33-50° F. (depending on the beverage and the user's preferences). The second temperature-activated thermochromic pigment may be provided in designs, messages, letters, numbers, or the like so that when the user drinks a cold beverage, the design, message, etc. becomes temporarily visible when the user smiles or otherwise bares their teeth and aligner(s).

As an option, the second temperature-activated thermochromic pigment may be provided by itself without the first temperature-activated thermochromic pigment, perhaps in a novelty and/or non-orthodontic device. For example, fake “vampire” teeth can be made to appear ivory in normal use but turn blood red when subjected to cold temperatures such as those of cold beverages. As another option, the first temperature-activated thermochromic pigment can also be provided in the same or similar novelty device; e.g., fake “vampire” teeth can be made to appear ivory prior to use but turn blood red when placed in the user's mouth and raised to body temperature. Other variations are also contemplated.

The invention is not limited to the above description. For example, while the aligner is shown as a full jaw aligner, the invention can also be for partial sets of teeth as well.

It should be understood that, in the context of this disclosure, “at least one of” followed by a series of elements means any one of the elements in the series or any combination of the elements in the series, including all of the elements. So, for example, a recitation of “at least one of A, B, or C”means any of A, B, C, A+B, A+C, B+C, or A+B+C.

Having described certain embodiments of the invention, it should be understood that the invention is not limited to the above description or the attached exemplary drawings. Rather, the scope of the invention is defined by the claims appearing hereinbelow and includes any equivalents thereof as would be appreciated by one of ordinary skill in the art.

What is claimed is:

1. A dental appliance, comprising:
a shell having a plurality of tooth-receiving cavities shaped to receive and resiliently reposition teeth in a patient's mouth from a first arrangement toward a second arrangement; and
at least one thermally-sensitive indicator incorporated with at least a portion of said shell.

2. A dental appliance according to claim 1, wherein said at least one thermally-sensitive indicator comprises a first temperature-activated thermochromic pigment.

3. A dental appliance according to claim 2, wherein said first temperature-activated thermochromic pigment changes from a first color when below a first temperature to a second color when above said first temperature.

4. A dental appliance according to claim 3, wherein said first color is visible and said second color is colorless and substantially clear, and wherein said first temperature is approximately human body temperature.

5. A dental appliance according to claim 3, wherein said first temperature-activated thermochromic pigment comprises a first leuco dye.

6. A dental appliance according to claim 5, wherein said first leuco dye is microencapsulated in a polymer.

7. A dental appliance according to claim 6, wherein said polymer comprises melamine formaldehyde polymer.

8. A dental appliance according to claim 2, wherein said at least one thermally-sensitive indicator comprises a second temperature-activated thermochromic pigment that changes from a third color when above a second temperature to a fourth color when below said second temperature.

9. A dental appliance according to claim 8, wherein said fourth color is visible and said third color is colorless and substantially clear.

10. A dental appliance according to claim 9, wherein said second temperature is approximately beverage-drinking temperature.

11. A dental appliance, comprising:
a shell having a plurality of tooth-receiving cavities; and
at least one thermally-sensitive indicator incorporated with at least a portion of said shell.

12. A dental appliance according to claim 11, wherein said at least one thermally-sensitive indicator comprises a first temperature-activated thermochromic pigment.

13. A dental appliance according to claim 12, wherein said first temperature-activated thermochromic pigment changes from a first color when below a first temperature to a second color when above said first temperature.

14. A dental appliance according to claim 13, wherein said first color is visible and said second color is colorless and substantially clear, and wherein said first temperature is approximately human body temperature.

15. A dental appliance according to claim 13, wherein said first temperature-activated thermochromic pigment comprises a first leuco dye.

16. A dental appliance according to claim 15, wherein said first leuco dye is microencapsulated in a polymer.

17. A dental appliance according to claim 16, wherein said polymer comprises melamine formaldehyde polymer.

18. A dental appliance according to claim 11, wherein said at least one thermally-sensitive indicator comprises a temperature-activated thermochromic pigment that changes from a first color when above a second temperature to a second color when below said second temperature.

19. A dental appliance according to claim 18, wherein said second color is visible and said first color is colorless and substantially clear.

20. A dental appliance according to claim 19, wherein said second temperature is approximately beverage-drinking temperature.
